(19) United States
(12) Patent Application Publication
(10) Pub. No.: US 2009/0065511 A1
(43) Pub. Date: Mar. 12, 2009

(54) TheVR

(75) Inventor: Michael P. Kehoe, Falls, PA (US)

Correspondence Address: MICHAEL P. KEHOE, RR # 1 BOX 55 RIVER RD., FALLS, PA, 18615, US

(73) Assignee: Michael P. Kehoe, Falls, PA (US)

(21) Appl. No.: 11/850,930

(22) Filed: Sep. 6, 2007

(51) Int. Cl. B65D 81/18; B67D 5/00

(52) U.S. Cl. 220/592.01; 220/592.28; 222/146.2

(57) ABSTRACT

A method and apparatus for making viscous products easier to work with by reducing their viscosity using regularly available heat sources.

### RELATED APPLICATIONS

N/A

### FIELD OF THE INVENTION

The present invention is concerned with reducing of the viscosity of viscous products, on demand, without excessive heating.

### BACKGROUND OF THE INVENTION

Viscous products are affected by the ambient temperature they are stored in. Therefore, before use, they are generally stored in a warm environment. This however often proves inadequate and or impractical.

Heating viscous products brings with it its own problems. Heating too quickly can, in some instances, be degrading to the product; in other instances can prove hazardous because of the fumes it releases. This can be especially so in the case of flammable products.

When heating is required it is necessary to preheat. Preheating can be done slowly until a predetermined temperature is obtained. By obtaining a predetermined temperature slowly overheating can be avoided.

Preheating requires the preheating of whatever amount of volume is currently being stored. This presents a constant problem since storage tanks vary greatly in size and the volume of product being stored in those storage tanks is generally greater then the current amount of product required for a particular application.

Having the ability to store a viscous product in any size container and in any volume while still being able to access any amount of product required for a particular application at a specific temperature would greatly simply and expedite working with a viscous product.

### SUMMARY OF THE INVENTION

This invention deals with these problems by means of a container that has an inlet large enough to allow a viscous product to flow into it unrestricted. Once inside the invention the viscous product then reaches multiple rows of heated coiled tubes wrapped around a center pipe.

Said coiled tubes being enclosed in said container, the individual rows of said coils tubes being spaced apart one from the other. As the viscous product flows through said container between the rows of said coiled tubes the heat from said coiled tubes is transferred to the viscous product thus lowering its viscosity.

Said coiled tubes being able to be heated by a variety of regularly available heat sources such as hot water, steam, hot gases, exhaust gases & hot oils.

Most regularly available heat sources have a preset temperature. Their preset temperature, in most cases, makes the invention fitting for use without further modification.

Since the invention is able to utilizing a wide variety of heat sources it is suitable for a wide variety of uses, at most locations.

Where the temperature of an available heat source is greater then, or lesser then, what is required for the viscous product that it will be used for, or where no heat source is available, a method of reducing or increasing or obtaining a heat source can be utilized.

By utilizing an available beat source whose heat is greater then required, such as steam and exhaust gas, or where the heat source is too low or not available an utilizing an electric heating element, and connecting said heat sources to a container containing a fluid, such as water or oil, the water or oil can then be quickly heat to a specified temperature.

Then by connecting said heated fluid to the inventions coiled tubes by means of a circulating pump the invention once again becomes suitable for properly heating a viscous product without excessive heating.

### BRIEF DESCRIPTION OF THE DRAWINGS

FIG. 1 Shows the inlet and outlet for the viscous product.

FIG. 2 Shows the inlet and outlet for the coiled tubes.

FIG. 3 Is a 3 dimensional view of the container showing the coiled tubes, in this case two rows of coiled tubes, and illustrates how the viscous product inlet utilizes the inventions center pipe to convey the viscous product into the invention.

FIG. 4 Is an alternative drawing where the viscous product inlet is required at opposite end of the container from the viscous product outlet.

FIG. 5 Shows another 3 dimensional view of the invention. In this case where the viscous product inlet and outlet are at opposite ends of the invention, in this case the center pipe does not convey the viscous product into the invention but is closed at both ends.

FIG. 6 Shows a view of how the first coiled tube is coiled around the center pipe.

FIG. 7 Shows a view of two rows of coiled tubes coiled around the center pipe.

FIG. 8 Is a cutaway of the invention showing the container, two rows of coiled tubes and the center pipe, in this instance shown open.

FIG. 9 Is a cutaway of the invention showing the container, multiple rows of coiled tubes and the center pipe, in this instance shown open.

FIG. 10 Is a drawing of the invention connected to a viscous product tank, alternative heat source a pump and a spray apparatus.

FIG. 11 Is a drawing of the invention connected to a viscous product tank, alternative heat source a pump, a spray apparatus all mounted on a trailer.

FIG. 12 Is a drawing of the invention connected to a viscous product tank, alternative heat source, a pump, a spray apparatus all mounted on a vehicle.

### DETAILED DESCRIPTION OF THE PREFERRED EMBODIMENT

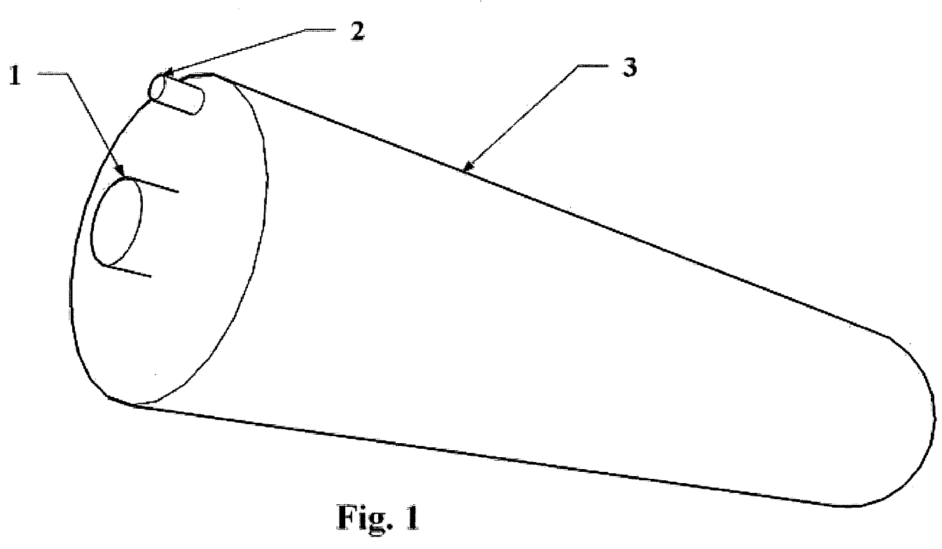

FIG. 1 After determining the viscosity of the product that will utilize the invention a diameter large enough to allow an unrestricted flow into the invention will become the diameter of inlet 1. Then an outlet size equivalent to what the invention will be attached to will become the diameter of outlet 2. The required rate of flow and maximum safe product temperature will determine the overall size of container 3 and total number of coiled tubes.

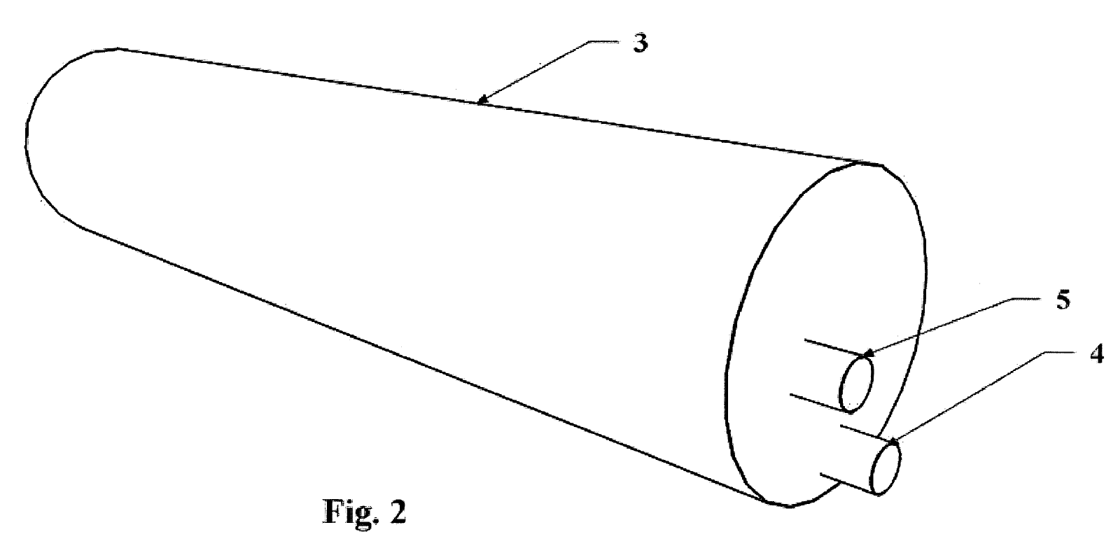

FIG. 2 Shows the heat source connections inlet 4 and outlet 5 of the coiled tubes.

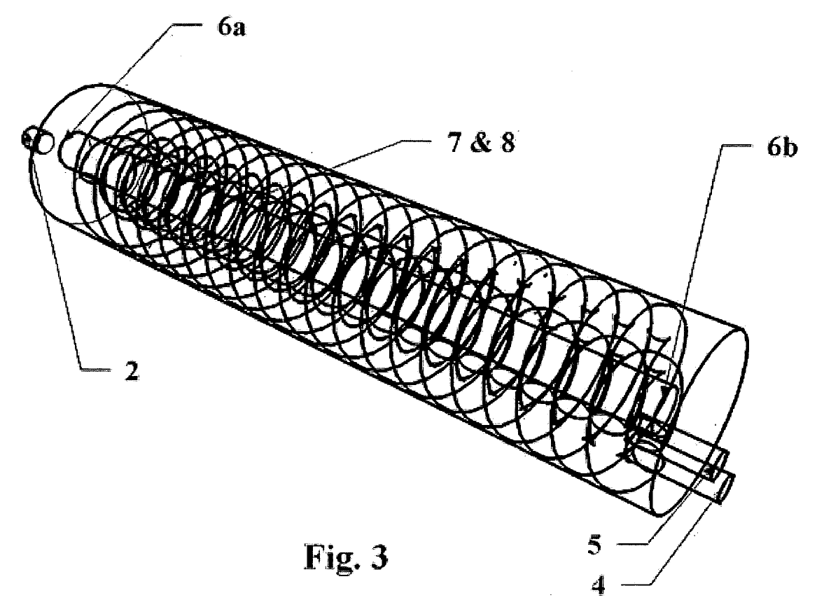

FIG. 3 Shows a 3 dimensional view of the invention and is an example of how the coiled tubes are utilized, wrapping one consecutively inside the other, as in this case with 7 & 8 leaving just enough space between the coiled tubes for the viscous product to flow past them in close enough proximity so as to transfer the heat from the coiled tubes to the viscous product. 6a & 6b shows how the center pipe can be utilized as the viscous product inlet to convey the viscous product into the invention. The center pipe 6b stops short of the end of the end of the invention, this allows the viscous product to reverse its direction of flow and return in the same direction from which it came. Inlet 4 & outlet 5 are for the coiled heating tubes. The viscous product outlet is 2.

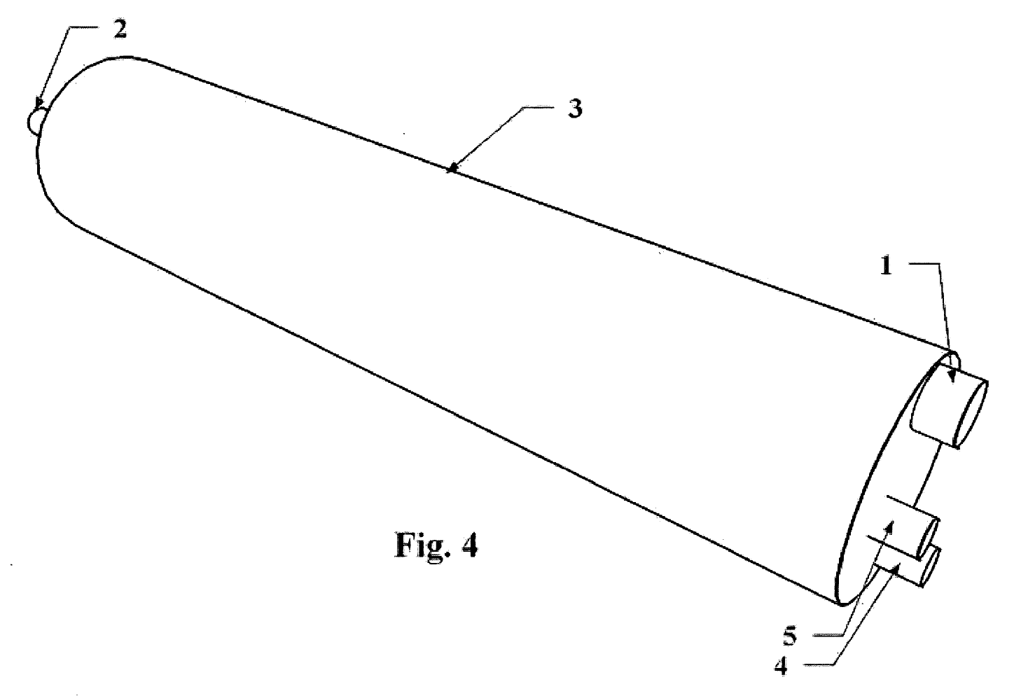

FIG. 4 Is a drawing where the viscous product inlet is required at opposite end of the container from the viscous product outlet. As with FIG. 1 after determining the viscosity of the intended product that will utilize the invention a diameter large enough to allow an unrestricted flow into the invention will become the diameter of inlet 1. Then an outlet size equivalent to what the invention will be attached to will become the diameter of outlet 2. After which the required rate of flow and maximum safe product temperature will determine the overall size of container 3 and total number of coiled heating tubes.

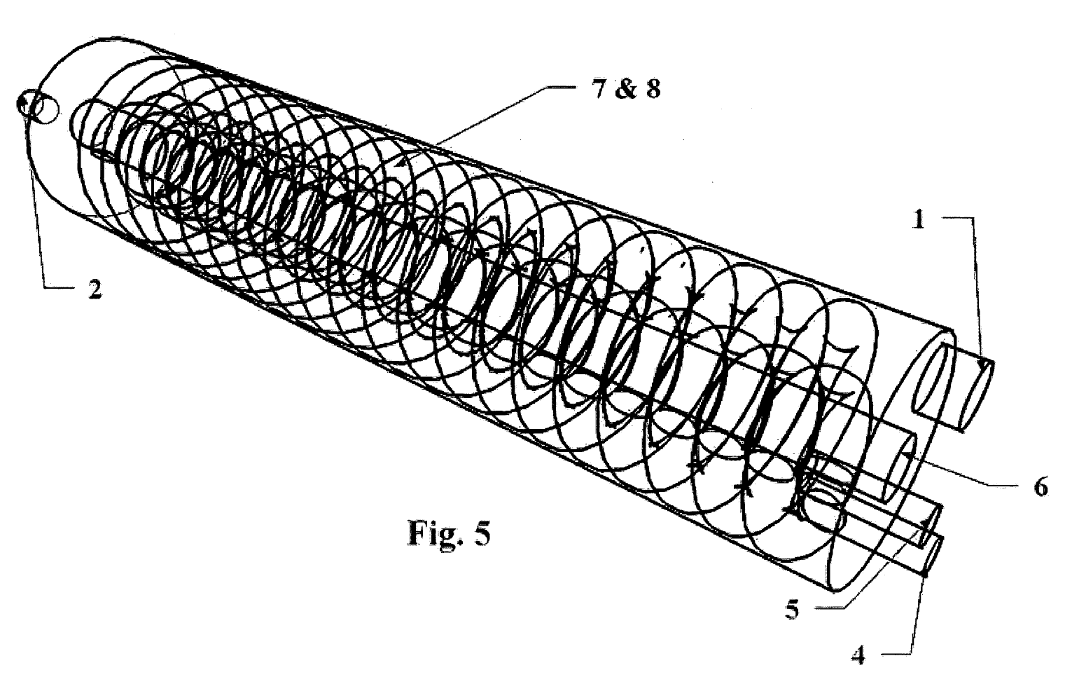

FIG. 5 Shows another 3 dimensional view of the invention. In this case where the viscous product inlet 1 and outlet 2 are at opposite ends of the invention. In this instance the center pipe 6 does not convey the viscous product into the invention but is closed at both ends. Inlet 4 & outlet 5 are for the coiled heating tubes. 7 & 8 is an example of how the coiled heating tubes are utilized, wrapping one consecutively inside the other.

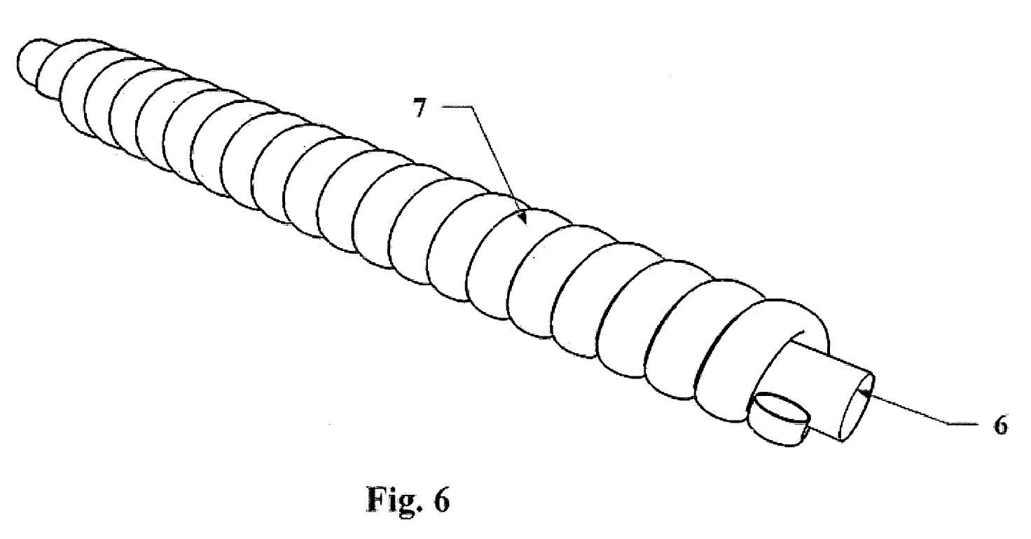

FIG. 6 Shows what the first coiled tubes look like when removed from the container. 7 being the coiled tube and 6 being the center pipe that the coiled tube is wrapped around. Said center pipe will serve to convey the viscous product into the invention as in FIG. 3 or as a pipe that is closed off at both ends as in FIG. 5.

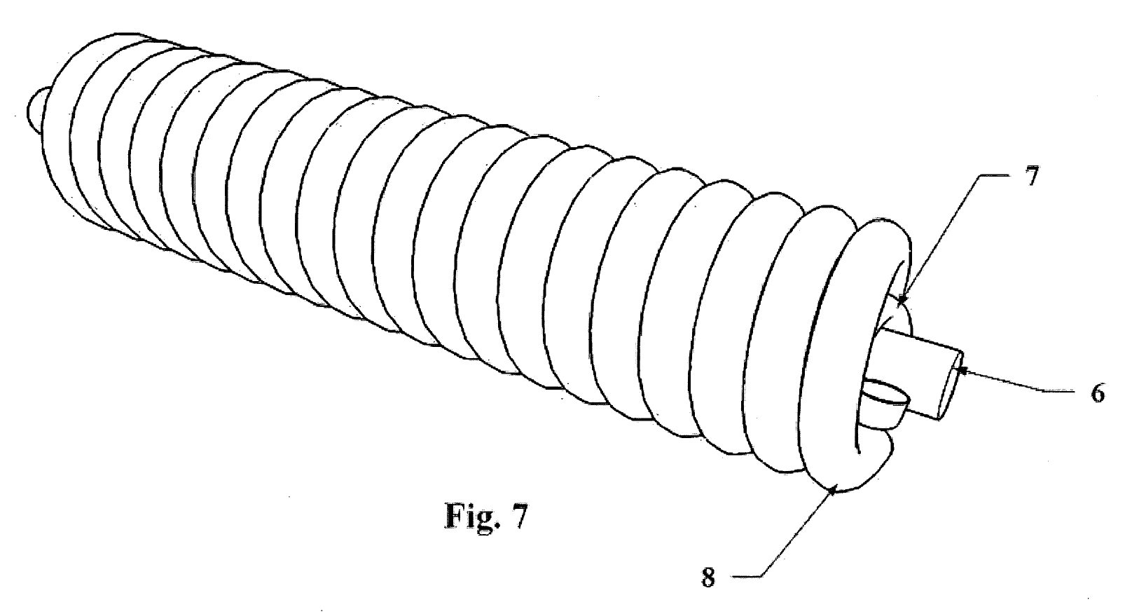

FIG. 7 Shows what the coiled tubes look like removed from their container. 7 being the inner coiled tube 8 being the outer coiled tube and 6 being the center pipe that the inner coiled tube is wrapped around. Said center pipe will serve to convey the viscous product into the invention as in FIG. 3 or as a pipe that is closed off at both ends as in FIG. 5.

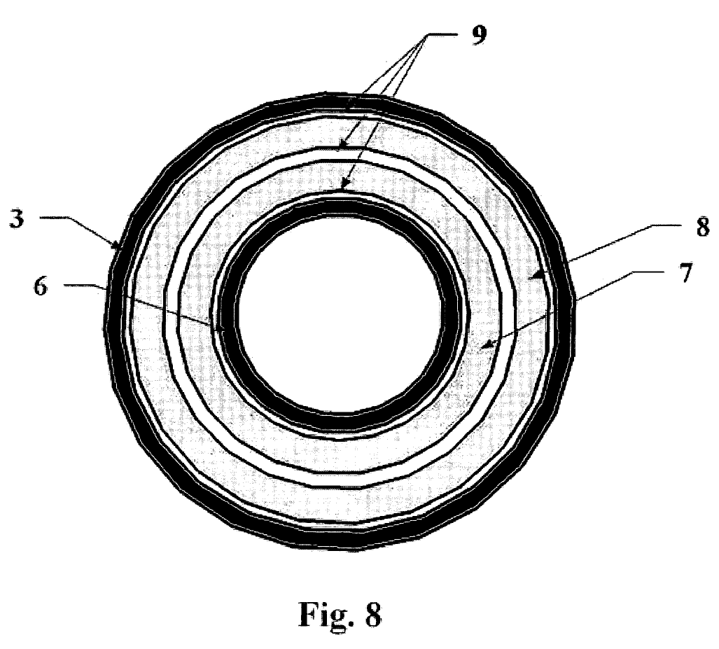

FIG. 8 Shows a cutaway of the invention with two coiled tubes, 3 is the container, 7 is the inner coiled tube, 8 is the outer coiled tube, 9 is the area the viscous product flows through, 6 is the center pipe, in this instance it is being displayed open, as in FIG. 3.

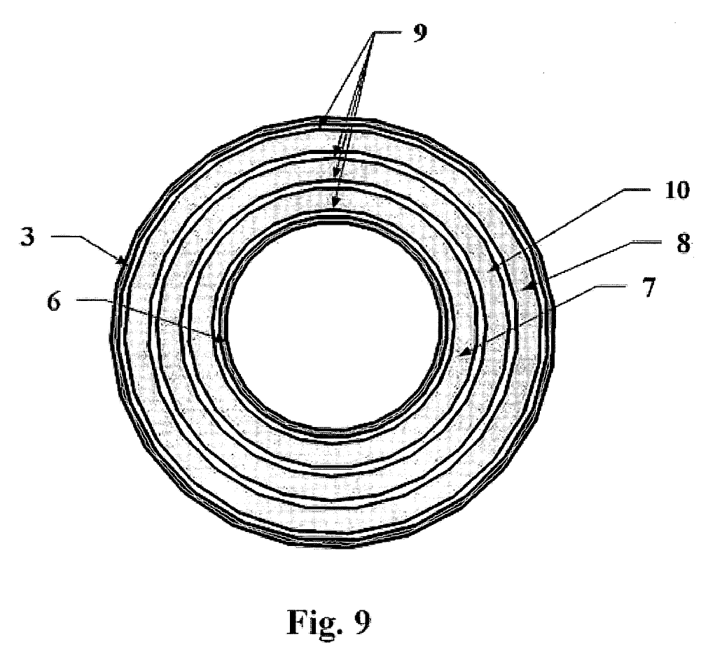

FIG. 9 Shows a cutaway of the invention with multiple coiled tubes, 3 is the container, 7 is the inner coiled tube, 8 is the outer coiled tube, 10 is the center coiled tube. When necessary, additional coiled tubes may be added. 9 is the area the viscous product flows through, 6 is the center pipe, in this instance it is being displayed open, as in FIG. 3.

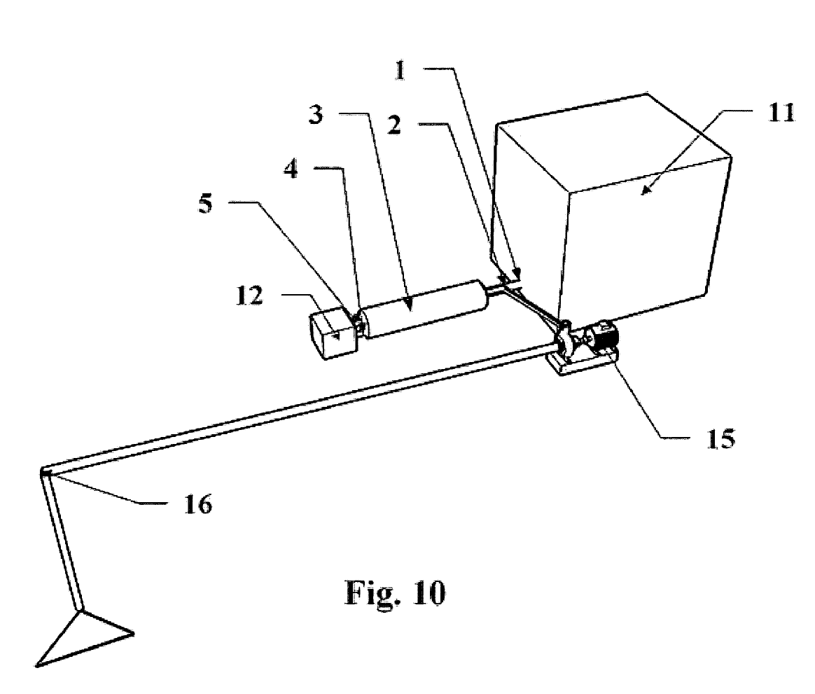

FIG. 10 Shows how the invention can be connected to a viscous product storage tank 11, and an alternative heat source 12 that will be used to heat the liquid for the invention 1 is the viscous product inlet 2 is the viscous product outlet 3 is the inventions container 4 is the inlet for the heat source 5 is the heat source outlet. 15 is a pump for the viscous product and 16 is a spray apparatus

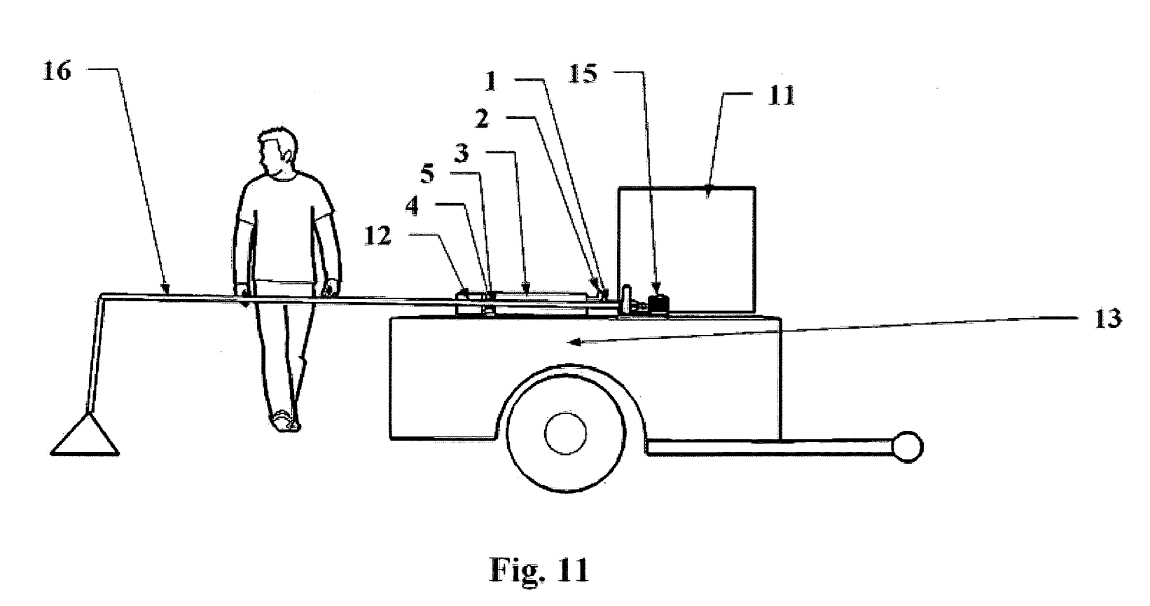

FIG. 11 Shows how the invention can be connected to a viscous product storage tank 11, and an alternative heat source 12 that will be used to heat the liquid for the invention's coiled tubes. 1 is the viscous product inlet 2 is the viscous product outlet 3 is the inventions container 4 is the inlet for the heat source 5 is the heat source outlet. 15 is a pump for the viscous product and 16 is a spray apparatus. All mounted on a trailer 13.

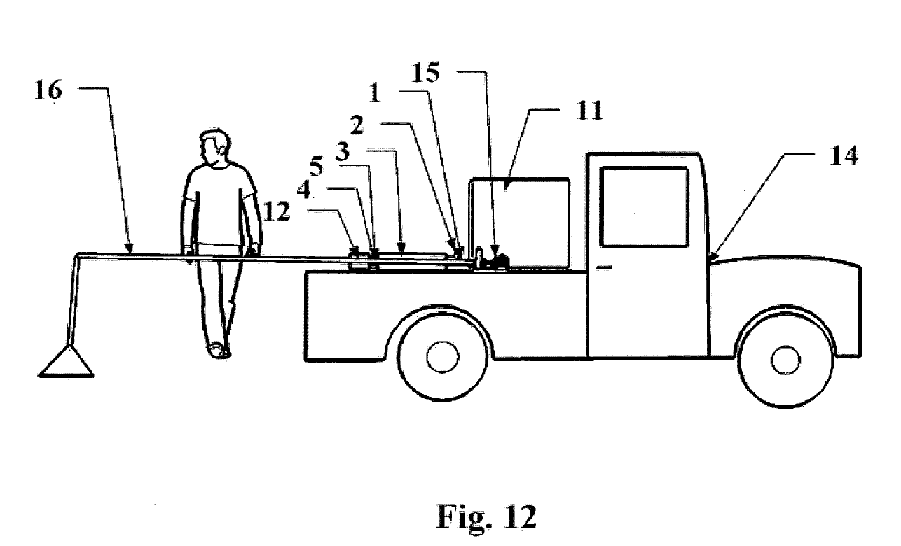

FIG. 12 Shows how the invention can be connected to a viscous product storage tank 11, and an alternative heat source 12 that will be used to heat the liquid for the invention's coiled tubes. 1 is the viscous product inlet 2 is the viscous product outlet 3 is the inventions container 4 is the inlet for the heat source 5 is the heat source outlet. 15 is a pump for the viscous product and 16 is a spray apparatus. All mounted on a motor vehicle.

I claim:

1. A viscosity reducing apparatus comprising:
a container containing coiled tubes a center pipe used as an inlet to convey the viscous product into the invention wherein said viscous product reverses direction of flow, an outlet for the viscous product and an inlet and outlet for the coiled tubes, wherein said coiled tube is wrapped around the center pipe and consecutive coiled tubes are wrapped around the inner coiled tube with a gap being left between said coiled tubes for the viscous product to flow around the coiled tubes.

2. A viscosity reducing apparatus comprising:
a container containing coiled tubes a center pipe that is closed at both ends, an inlet and outlet for the viscous product and an inlet and outlet for the coiled tubes, wherein said coiled tube is wrapped around the center pipe and consecutive coiled tubes are wrapped around inner coiled tubes with a gap being left between said coiled tubes for the viscous product to flow around the coiled tubes.

3. The viscosity reducing apparatus of claim 1 wherein:
the container is selected from a group consisting of: steel or aluminum

4. The viscosity reducing apparatus of claim 1 wherein:
the coiled tubes are selected from a group consisting of: copper, steel, or aluminum

5. The viscosity reducing apparatus of claim 1 wherein:
a heating source is selected from a group consisting of: hot water, hot oil, steam, heated gas, exhaust gases and electric.

6. A system comprising:
a container containing coiled tubes an inlet and an outlet for the viscous product and an inlet and outlet for the coiled tubes and a heating source for the coiled tubes wherein said container and said heating source are connected together.

7. The system of claim 6 further comprising:
a storage tank for the viscous product wherein said container said heating source and said storage tank are connected together.

8. The system of claim 6 further comprising:
a trailer having at least two wheels, a chassis, and a storage tank for the viscous product wherein said trailer said container, said heating source, and said storage tank are connected together.

9. The system of claim 6 further comprising:
a vehicle having at least four wheels, a chassis, and a storage tank for the viscous product wherein said motor vehicle, said container, said heating source and said storage tank are connected together.
